(19) United States
(12) Patent Application Publication
(10) Pub. No.: US 2011/0145046 A1
(43) Pub. Date: Jun. 16, 2011

(54) REWARD SYSTEM FOR DISTRIBUTION OF ADVERTISEMENTS

(75) Inventor: Oscar López Logroño, Martutene (ES)

(73) Assignee: SERDIST 21, S.L., Martutene (ES)

(21) Appl. No.: 12/638,569

(22) Filed: Dec. 15, 2009

(51) Int. Cl. G06Q 30/00

(52) U.S. Cl. 705/14.17

(57) ABSTRACT

An advertiser distributes advertisements to a consumer. Subsequently, a computing system associated with the advertiser receives reward requests from the consumers when the consumers have consumed the advertisements and from participating merchants when the consumers perform transactions with the participating merchants. In response to receiving the reward requests, monetary rewards are credited to rewards accounts. The rewards accounts exclusively contain money from monetary rewards credited to the rewards accounts by the advertiser. The consumers are able to use money in the rewards accounts for purchases from participating merchants and non-participating merchants. By providing monetary rewards for consuming advertisements, the consumer is incentivized to consume the advertisements. In other words, the consumer is able to build a balance in the rewards account by consuming advertisements.

### BACKGROUND

People consume advertisements in different ways depending on the types of the advertisements. For example, people consume printed advertisements, e-mail advertisements, and click-through advertisements by reading such advertisements. In another example, people consume audio advertisements by listening to such advertisements. In yet another example, people consume video advertisements by watching and listening to such advertisements.

Advertisers can distribute a large number of advertisements. However, the advertisements are not effective unless the people receiving the advertisements actually consume the advertisements. For example, a mailed advertisement is not effective unless the recipient of the mailed advertisement actually reads the mailed advertisement.

There are many reasons why people choose not to consume the advertisements they receive. For instance, some people may choose not to consume paper advertisements because of the time required to open and sort through stacks of paper advertisements. In another instance, some people may choose not to consume e-mail advertisements because people are overwhelmed by the volume of the e-mail advertisements and are concerned by the potential security risks associated with opening unsolicited e-mail messages.

### SUMMARY

An advertiser distributes advertisements to a consumer. Subsequently, a computing system associated with the advertiser receives reward requests from the consumers when the consumers have consumed the advertisements and from participating merchants when the consumers perform transactions with the participating merchants. In response to receiving the reward requests, monetary rewards are credited to rewards accounts. The rewards accounts exclusively contain money from monetary rewards credited to the rewards accounts by the advertiser. The consumers are able to use money in the rewards accounts for purchases from participating merchants and non-participating merchants. By providing monetary rewards for consuming advertisements, the consumer is incentivized to consume the advertisements.

One aspect is a computer-implemented method for distributing advertisements. The computer-implemented method comprises distributing, by an advertiser, advertisements to consumers. The computer-implemented method also comprises receiving, by a computing system associated with the advertiser, reward requests from the consumers when the consumers have consumed the advertisements and from participating merchants when the consumers perform transactions with the participating merchants. Furthermore, the computer-implemented method comprises, in response to receiving the reward requests, crediting monetary rewards to rewards accounts. The rewards accounts exclusively contain money from monetary rewards credited to the rewards accounts by the advertiser. The consumers are able to use money in the rewards accounts for purchases from participating merchants and non-participating merchants.

Another aspect is a computing system comprising a set of computing devices. The set of computing devices includes at least one computing device. The set of computing devices is configured such that the computing system distributes advertisements to consumers. The set of computing devices also receives reward requests from consumers when the consumers have consumed the advertisements and from participating merchants when the consumers perform transactions with the participating merchants. In addition, the set of computing devices, in response to receiving the reward requests, credits monetary rewards to rewards accounts. The rewards accounts exclusively contain money from monetary rewards credited to the rewards accounts by an advertiser. The consumers are able to use money in the rewards accounts for purchases from participating merchants and non-participating merchants.

Yet another aspect is a computer-readable data storage medium comprising instructions. The instructions, when executed by a processing unit of a computing device, cause the computing device to distribute advertisements to consumers. The instructions also cause the computing device to receive reward requests from the consumers when the consumers have consumed the advertisements and from participating merchants when the consumers perform transactions with the participating merchants. In response to receiving the reward requests, the instructions cause the computing device to credit monetary rewards to rewards accounts. The rewards accounts exclusively contain money from monetary rewards credited to the rewards accounts by an advertiser. The consumers are free to use money in the rewards accounts for purchases from participating merchants and non-participating merchants.

### BRIEF DESCRIPTION OF THE DRAWINGS

FIG. 1 is a block diagram illustrating an example advertising system.

FIG. 2 is a block diagram illustrating logical components of an advertiser computing system.

FIG. 3 is a flowchart illustrating an example operation to register a consumer.

FIG. 4 is a flowchart illustrating an example operation to distribute advertisements.

FIG. 5 is a flowchart illustrating an example operation to process rewards.

FIG. 6 is a flowchart illustrating an example operation to provide a virtual shopping center website.

FIG. 7 is a block diagram illustrating an example computing device usable in the advertising system.

### DETAILED DESCRIPTION

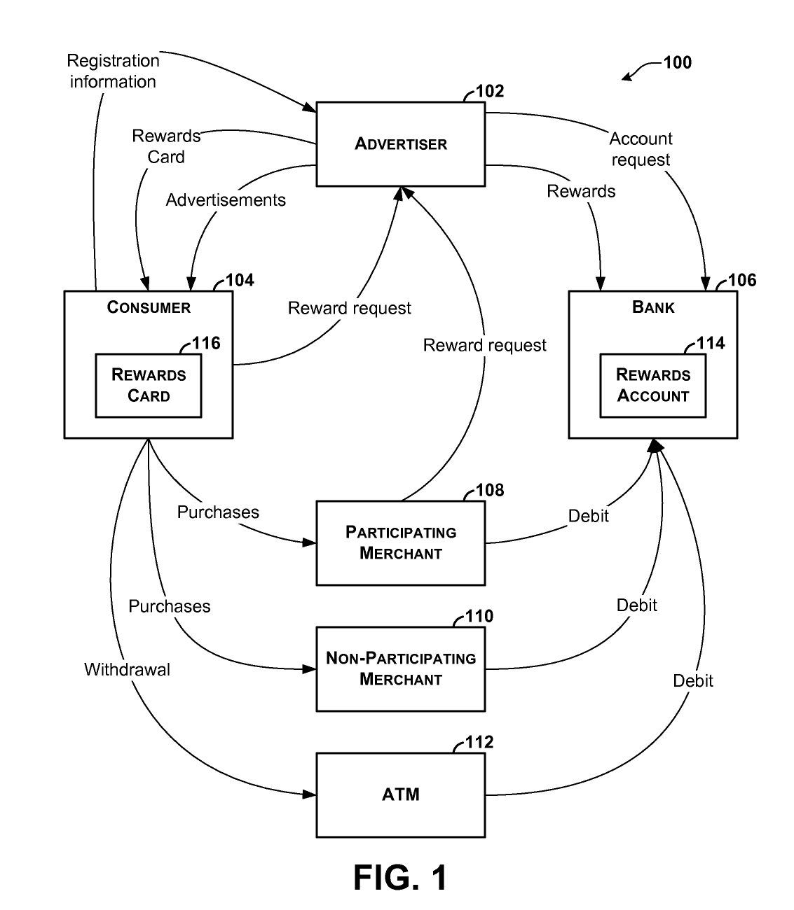

FIG. 1 is a block diagram illustrating an example advertising system 100. As illustrated in the example of FIG. 1, the advertising system 100 includes an advertiser 102, a consumer 104, a bank 106, a participating merchant 108, a non-participating merchant 110, and an automatic teller machine (ATM) 112. It should be appreciated that in other embodiments, the advertising system 100 may include additional consumers, banks, participating merchants, non-participating merchants, ATMs, and/or other entities or devices.

The advertiser 102 is an entity that distributes advertisements to consumers on behalf of one or more third parties. An advertisement is an announcement that calls attention to something. Example types of advertisements include e-mail advertisements, leaflets, flyers, web page banner adds, and so on. In various embodiments, the advertiser 102 can be various types of entities. For example, in various embodiments, the advertiser 102 can be a business entity (e.g., a corporation, a company, a partnership, a proprietorship, etc.), a non-profit entity (e.g., a foundation, a charity, a religious organization, etc.), a government entity (e.g., a national agency, a bureau, a city, a province, a military organization, an international agency, etc.), an individual, or another type of entity.

The consumer 104 is an entity that receives advertisements distributed by the advertiser 102. In various embodiments, the consumer 104 can be various types of entities. For example, in various embodiments, the consumer 104 can be a business entity, a non-profit entity, a government entity, an individual, or another type of entity.

The participating merchant 108 is an entity that participates in an advertiser network operated by the advertiser 102. The non-participating merchant 110 is an entity that does not participate in the advertiser operated by the advertiser 102. The advertising network is a network of entities who participate in an advertising system. As used herein, a merchant is an entity that offers goods or services for sale. In various embodiments, the participating merchant 108 and the non-participating merchant 110 may be various types of entities. For example, in various embodiments, the participating merchant 108 and/or the non-participating merchant 110 may be business entities, non-profit entities, government entities, individuals, or other types of entities.

In the example embodiment illustrated in FIG. 1, the participating merchant 108 and the non-participating merchant 110 are merchants. It should be appreciated that in alternate embodiments, the participating merchant 108 and/or the non-participating merchant 110 may be replaced by entities who do not offer goods or services for sale. For example, in one alternate embodiment, the participating merchant 108 is replaced by a non-profit foundation that uses the advertiser 102 to distribute public service announcements that encourage consumers to quit smoking and receives donations from consumers.

In the advertising system 100, the advertiser 102 provides a registration form to the consumer 104. In various embodiments, the advertiser 102 provides the registration form to the consumer 104 in various ways. For example, in some embodiments, the advertiser 102 provides a paper registration form to the consumer 104. In other embodiments, the advertiser 102 provides a web page to the consumer 104. The web page contains the registration form.

The consumer 104 uses the registration form to provide registration information to the advertiser 102. The registration information comprises personal information about the consumer 104. In various embodiments, the registration information comprises various types of personal information about the consumer 104. For example, in some embodiments, the registration information comprises a personal e-mail address of the consumer. Furthermore, in some embodiments, the registration information may include information indicating a preferred way of the consumer 104 to receive advertisements. In addition, in some embodiments, the registration information includes information regarding personal interests and/or buying habits of the consumer 104.

In various embodiments, the consumer 104 provides the registration information to the advertiser 102 in various ways. For example, in one embodiment, the consumer 104 provides the registration information to the advertiser 102 via paper mail. In another example embodiment, the consumer 104 uses a computing device to provide the registration information to the advertiser 102 via e-mail. In yet another example embodiment, the consumer 104 uses a computing device to provide the registration information to the advertiser 102 via a web interface.

When the advertiser 102 receives the registration information, the advertiser 102 provides an account request to the bank 106. The bank 106 is a financial institution. In various embodiments, the bank 106 can be various types of financial institutions. For instance, the bank 106 may be a federally-chartered bank, a state-chartered bank, a savings and loan bank, a community development bank, a savings bank, an Islamic bank, an investment bank, or another type of financial institution.

When the bank 106 receives the account request from the advertiser 102, the bank 106 establishes a rewards account 114 for the consumer 104. The rewards account 114 is a fund containing money credited to and subject to withdrawal by the consumer 104. The rewards account 114 exclusively contains money from monetary rewards credited to the rewards account 114 by the advertiser 102. The advertiser 102 does not restrict how the consumer 104 uses money in the rewards account 114. For instance, the consumer 104 is free to use money in the rewards account 114 for purchases from the participating merchant 108 and the non-participating merchant 110.

In some embodiments, the rewards account 114 is interest-bearing. In other words, money in the rewards account 114 accumulates interest. In such embodiments, the rewards account 114 is a savings account. A savings account is an account in which a depositor is only permitted to make a limited number of withdrawals, payments, and transfers during a statement cycle (e.g., six withdrawals per month). In other embodiments, the rewards account 114 is a checking account, a money market deposit account, or another type of fund containing money credit to and subject to withdrawal by the consumer 104.

Furthermore, when the advertiser 102 receives the registration information from the consumer 104, the advertiser 102 sends a rewards card 116 to the consumer 104. In some embodiments, the rewards card 116 is a physical card, such as a debit card or a credit card. The physical card contains account information. The account information identifies the rewards account 114. The account information may, in some embodiments, include an account number of the rewards account 114. In other embodiments, the rewards card 116 is a virtual card that does not have a physical embodiment, but rather is a data structure that comprises account information identifying the rewards account 114. Furthermore, in some embodiments, the registration information includes data indicating whether the consumer 104 prefers to receive a physical rewards card and/or a virtual rewards card.

After the bank 106 establishes the rewards account 114 and the consumer 104 receives the rewards card 116, the advertiser 102 begins distributing advertisements to the consumer 104. In various embodiments, the advertiser 102 distributes various types of advertisements to the consumer 104. In one example embodiment, the advertiser 102 sends paper advertisements to the consumer 104 via a postal service or via a private delivery service. In another example embodiment, the advertiser 102 distributes various types of electronic advertisements to the consumer 104. In one instance, the advertiser 102 sends e-mail messages containing the advertisements to the consumer 104. In another instance, the advertiser 102 provides a website to the consumer 104. The website contains advertisements.

The consumer 104 is able to use the rewards card 116 to make purchases from participating merchants (e.g., the participating merchant 108) and non-participating merchants (e.g., the non-participating merchant 110). For example, the consumer 104 may be able to use the rewards card 116 to purchase sporting goods from the participating merchant 108.

The consumer 104 is able to use the rewards card 116 to make purchases from merchants in a variety of ways. For example, if the rewards card 116 is a physical card, the consumer 104 is able to make a purchase from a merchant by presenting the rewards card 116 at a point of sale. In this example, a representative of the merchant obtains the account information from the rewards card 116 by swiping the rewards card 116 through a card reader or otherwise copying the account information from the rewards card 116. In another example, the consumer 104 is able to make a purchase from a merchant by providing the account information of the rewards card 116 to the merchant via a voice telephone call. In yet another example, the consumer 104 is able to use a computer device to make a purchase from a merchant by providing the account information of the rewards card 116 to the merchant via a web interface. Example types of web interfaces include web sites, client applications that interact with web services, or other types of electronic interfaces.

When the consumer 104 uses the rewards card 116 to make a purchase from a merchant (e.g., the participating merchant 108 or the non-participating merchant 110), the merchant causes a debit to be issued against the rewards account 114 in the amount of the price of the purchase. For example, if the price of the purchase was $75, the merchant causes a debit to be issued against the rewards account 114 in the amount of $75.

In various embodiments, the merchant causes the debit to be issued against the rewards account 114 is various ways. For example, in one embodiment, when the consumer 104 provides the rewards card 116 to the merchant, the merchant submits an authorization request to an acquiring bank. The acquiring bank is a bank accepting payment on behalf the merchant. The acquiring bank may or may not be the bank 106. If the acquiring bank authorizes the purchase, the merchant accepts the purchase and sends a record of the purchase to the acquiring bank in a batch. If the acquiring bank is the bank 106, the acquiring bank issues the debit against the rewards account 114 and credits an account of the merchant. If the acquiring bank is not the bank 106, the acquiring bank communicates with the bank 106 to issue the debit against the rewards account 114.

In the example of FIG. 1, the consumer 104 is also able to use the rewards card 116 at the ATM 112 to withdraw money from the rewards account 114. When the consumer 104 uses the rewards card 116 at the ATM 112 to withdraw money from the rewards account 114, the ATM 112 provides cash to the consumer 104. In addition, the ATM 112 causes a debit to be issued against the rewards account 114 in accordance with an amount of money withdrawn by the consumer 104. In some embodiments, the ATM 112 uses a process similar to that described above with regard to merchants to issue the debit against the rewards account 114.

When the consumer 104 receives various kinds of advertisements and consumes the advertisements, the consumer 104 provides a reward request to the advertiser 102. The reward request indicates to the advertiser 102 that the consumer 104 has absorbed information in the advertisements. As used herein, a consumer consumes advertisements when the consumer absorbs the advertisements. Absorbing the advertisements may include skimming the advertisements, reading the advertisements, reviewing the advertisements, watching the advertisements, listening to the advertisements, taking actions in response to the advertisements, and so on. For example, the advertiser 102 may send an e-mail message containing an advertisement for a product to the consumer 104. In this example, the advertiser 102 receives an indication from a computing device used by the consumer 104 that the consumer 104 has read the e-mail message. For instance, the e-mail message may include a link to additional information about the product. In this example, a computing device associated with the advertiser 102 receives a reward request when the consumer 104 clicks on the link to receive additional information about the product.

In response to receiving a reward request from the consumer 104, the advertiser credits a monetary reward to the rewards account 114. For example, advertiser 102 may credit $0.25 to the rewards account 114 when the consumer 104 clicks on a link in an e-mail message to additional information about a product or service.

When the consumer 104 uses the rewards card to make a purchase at the participating merchant 108, the participating merchant 108 provides a reward request to the advertiser 102. The reward request notifies the advertiser 102 that the consumer 104 has performed a transaction with the participating merchant 108. In various embodiments, the reward request includes various types of information. For example, in some embodiments, the reward request includes data identifying the consumer 104, the participating merchant 108, and a monetary amount of the transaction. In other example embodiments, the reward request also includes information about the types of goods and services purchased by the consumer 104.

In various embodiments, the advertiser 102 performs various actions in response to receiving a reward request from the participating merchant 108. For example, in one embodiment, the advertiser 102 credits a monetary reward to the rewards account 114 in response to receiving a reward request from the participating merchant 108. In another embodiment, the consumer 104 may opt to receive an instant discount from the participating merchant 108 in lieu of receiving a credit of a monetary reward in the rewards account 114. In yet another embodiment, the consumer 104 may opt to use money in the rewards account 114 to reduce a purchase price of a purchase from the participating merchant 108 at a time when the consumer 104 makes the purchase.

In some embodiments, the participating merchant 108 sends reward requests to the advertiser 102 whenever the consumer 104 performs a transaction with the participating merchant 108, regardless of whether the participating merchant 108 is currently using the advertiser 102 to distribute advertisements to consumers. In this way, the consumer 104 is rewarded for continued loyalty to the participating merchant 108.

In some embodiments, the advertiser 102 operates a virtual shopping center website. The virtual shopping center website is a website comprising one or more web pages. The web pages include features that allow consumers to perform transactions with participating merchants (e.g., the participating merchant 108) using the rewards card 104 or another form of payment. In some embodiments, the virtual shopping center website allows consumers to perform transactions with a large number of participating merchants. The advertiser 102 distributes some types of advertisements of participating merchants to consumers via the virtual shopping center website. As described herein, consumers are rewarded for consuming advertisements distributed via the virtual shopping center website and for performing transactions with participating merchants through the virtual shopping center website.

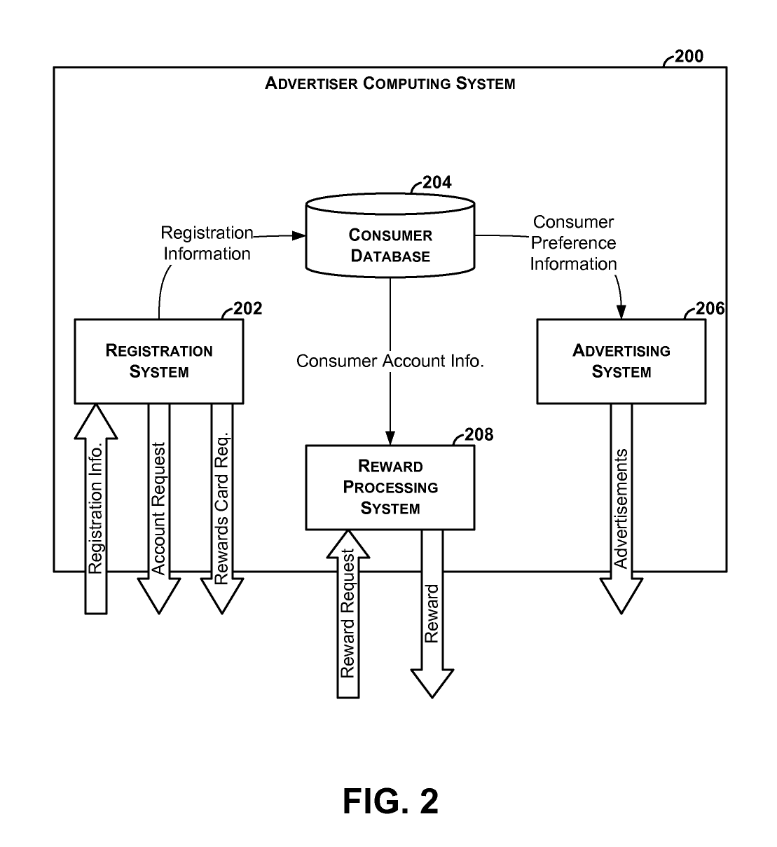

FIG. 2 is a block diagram illustrating logical components of an advertiser computing system 200. It should be appreciated that in various embodiments, the advertiser computing system 200 may comprise logical components other than those illustrated in the example of FIG. 2.

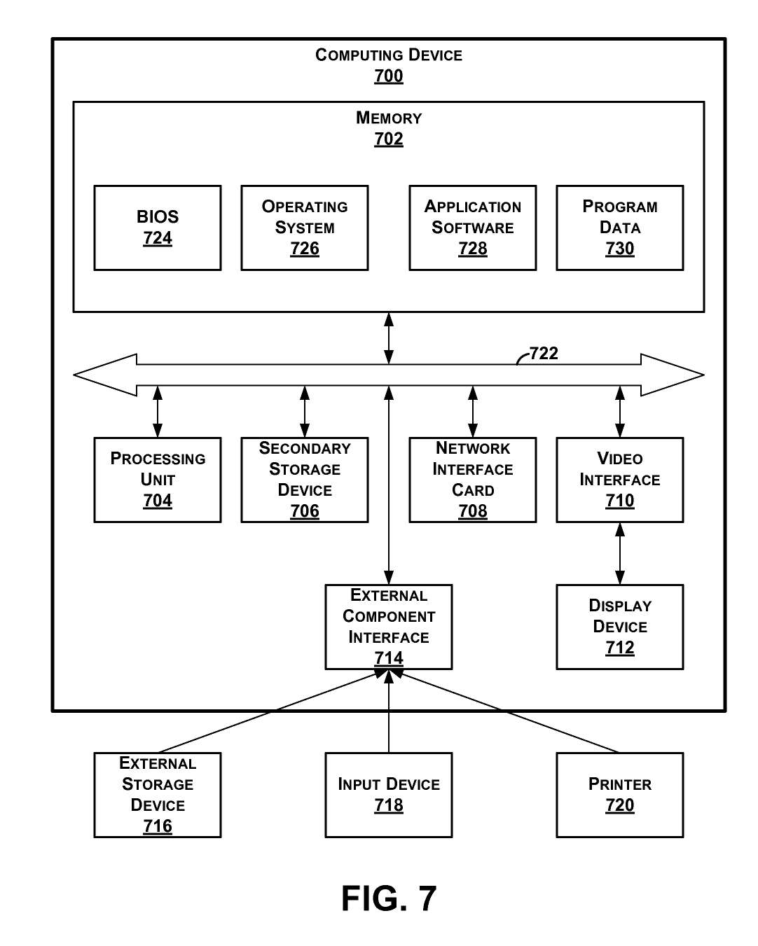

The advertiser computing system 200 is a computing system utilized by the advertiser 102. As used herein, a computing system is a set of one or more physical electronic computing devices. In some embodiments, the advertiser computing system 200 comprises one or more computing devices of a type described with regard to FIG. 7. In various embodiments, the advertiser computing system 200 is implemented in various ways. For example, in one example embodiment, the advertiser computing system 200 is implemented as one or more server devices or personal computer devices operated by the advertiser 102. In another example embodiment, the advertiser computing system 200 is implemented based on a cloud computing paradigm. That is, the advertiser computing system 200 comprises one or more server devices operated by a third party. The one or more server devices provide some or all of the functionality of the advertiser computing system 200. This functionality, from the perspective of the advertiser 102, is provided by “the cloud.”

As illustrated in the example of FIG. 2, the advertiser computing system 200 comprises a registration system 202, a consumer database 204, an advertising system 206, and a reward processing system 208. In various embodiments, the registration system 202, the consumer database 204, the advertising system 206, and the reward processing system 208 are implemented in various ways. For example, the registration system 202, the consumer database 204, the advertising system 206, and/or the reward processing system 208 can be implemented as sets of computer-executable instructions stored on one or more computer-readable data storage media. When executed by one or more processing units in the advertiser computing system 200, the sets of computer-executable instructions cause the advertiser computing system 200 to provide the functionality ascribed herein to the registration system 202, the consumer database 204, the advertising system 206, and/or the reward processing system 208. In another example, the registration system 202, the consumer database 204, the advertising system 206, and/or the reward processing system 208 can be implemented in whole or in part using application-specific integrated circuits that operate to provide the functionality ascribed herein to the registration system 202, the consumer database 204, the advertising system 206, and/or the reward processing system 208.

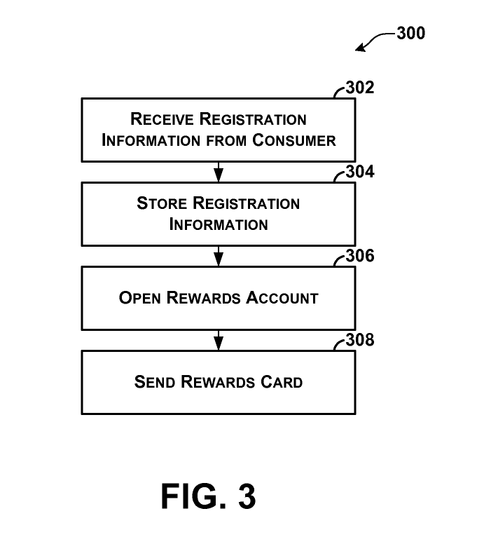

The registration system 202 receives registration information from consumers such as the consumer 104 (FIG. 1). When the registration system 202 receives registration information from a consumer, the registration system 202 stores the registration information into the consumer database 204. Furthermore, when the registration system 202 receives registration information from a consumer, the registration system 202 outputs a request to a bank to open a rewards account for the consumer (i.e., an account request). In addition, when the registration system 202 receives the registration information from a consumer, the registration system 202 outputs a request to send a rewards card to the consumer. Additional detail about the functionality of the registration system 202 is provided with regard to FIG. 3.

The consumer database 204 stores registration information. In various embodiments, the consumer database 204 is implemented in various ways. For instance, in various embodiments, the consumer database 204 according to various architectures, such as relational database architectures, object-oriented database architectures, associative database architectures, or other database architectures.

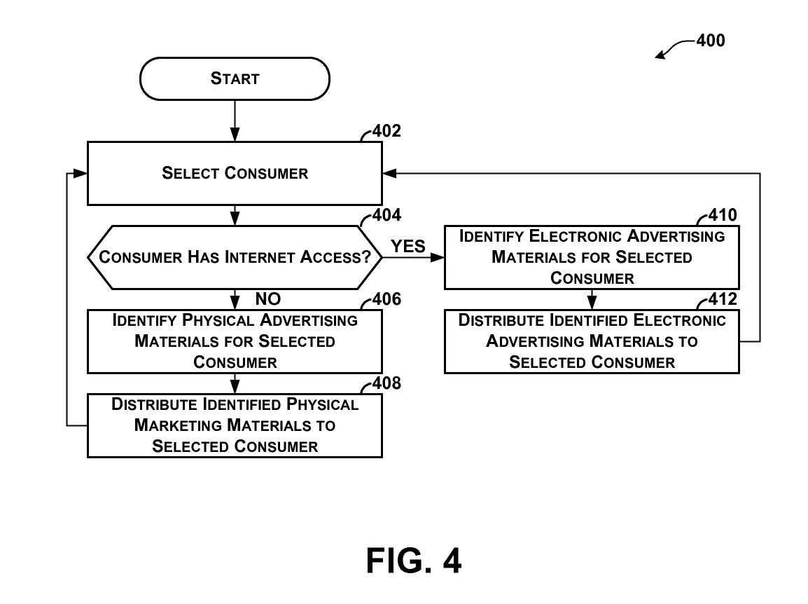

The advertising system 206 distributes advertisements (i.e., ads) to consumers who have provided registration information to the advertiser computing system 200. To distribute the advertisements to the consumers, the advertising system 206 extracts consumer preference information for the consumers from the consumer database 204. The consumer preference information for a consumer is information about the preferences of the consumer. The advertising system 206 selectively distributes advertisements to the consumer based on the consumer preference information for the consumer. Additional detail about the functionality of the advertising system 206 is provided with regard to FIG. 4.

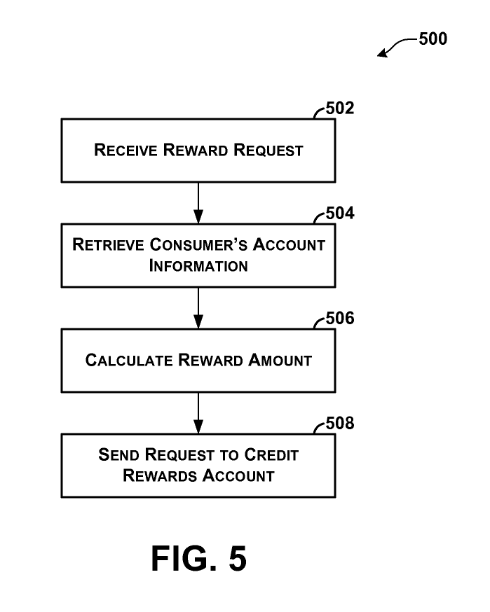

The reward processing system 208 receives reward requests from consumers and participating merchants. For instance, the reward processing system 208 may receive reward requests from the consumer 104 and the participating merchant 108 (FIG. 1). In response to receiving a reward request regarding a consumer, the reward processing system 208 extracts consumer account information for the consumer from the consumer database 204. The consumer account information for the consumer identifies a rewards account for the consumer. For instance, when the reward processing system 208 receives a reward request regarding the consumer 104, the consumer account information identifies the rewards account 114 (FIG. 1). The reward processing system 208 uses the consumer account information to apply a monetary reward to the rewards account of the consumer. Additional detail about the functionality of the reward processing system 208 is provided with regard to FIG. 5.

FIG. 3 is a flowchart illustrating an example operation 300 to register the consumer 104. It should be appreciated that the operation 300 is merely one example. In other embodiments, operations to register the consumer 104 include more or fewer steps or contain the steps of the operation 300 in different sequences.

As illustrated in the example of FIG. 3, the operation 300 begins when the registration system 202 receives registration information from the consumer 104 (302). In various embodiments, the registration system 202 receives the registration information from the consumer in various ways. In one example embodiment, the registration system 202 hosts one or more registration web pages. The consumer uses a computing device to retrieve and render the web pages. The registration web pages contain web forms having features into which the consumer enters at least some of the registration information. When the consumer has completed the web forms, the consumer's computing device sends the registration information to the registration system 202 via a computer network using a networking protocol such as Hypertext Transfer Protocol (HTTP). In another example embodiment, the advertiser 102 sends a printed registration form to the consumer. In this other example embodiment, the consumer 104 writes the registration information on the printed registration form and mails the printed registration form to the advertiser 102.

Next, the registration system 202 stores the registration information in the consumer database 204 (304). In some embodiments, the registration system 202 processes the registration information prior to storing the registration information in the consumer database 204. For example, in one embodiment, the registration system 202 calculates an estimated income level of the consumer 104 based on the job held by the consumer 104 and the address of the consumer 104. In this example, the registration system 202 stores the estimated income level of the consumer 104 into the consumer database 204 along with other registration information provided by the consumer 104.

Furthermore, the registration system 202 sends an account request to the bank 106 to open a rewards account for the consumer (306). In various embodiments, the registration system 202 sends the account request in various ways. For example, in one embodiment, the advertiser 102 and the bank 106 have established a secure electronic channel by which the registration system 202 electronically sends the account request. In another embodiment, the registration system 202 operates to send printed documents to the bank 106 to open a rewards account.

Next, the registration system 202 sends a rewards card to the consumer 104 (308). In various embodiments, the registration system 202 sends the rewards card to the consumer 104 in various ways. For example, in one embodiment, the registration system 202 operates to send a physical rewards card to the consumer 104 by mail. In another example embodiment, the registration system 202 sends a virtual rewards card to the consumer 104 by e-mail or other electronic communication means.

FIG. 4 is a flowchart illustrating an example operation 400 to distribute advertisements to consumers. It should be appreciated that the operation 400 is merely one example. In other embodiments, operations to distribute advertisements to consumers include more or fewer steps or contain the steps of the operation 400 in different sequences.

In the example of FIG. 4, the operation 400 starts when the advertising system 206 selects a consumer from among the consumers who have provided registration information to the advertiser computing system 200 (i.e., registered consumers) (402).

After selecting the consumer, the advertising system 206 determines whether the selected consumer has internet access (404). In various embodiments, the advertising system 206 determines whether the selected consumer has internet access in various ways. In one example embodiment, the consumer database 204 stores data for each registered consumer indicating whether the registered consumers have internet access. In this example embodiment, the advertising system 206 determines whether the selected consumer has internet access by querying the consumer database 204 for the data indicating whether the selected consumer has internet access.

If the selected consumer does not have internet access (“NO” of 404), the advertising system 206 identifies physical advertisements for the selected consumer (406). In various embodiments, the physical advertisements include various types of physical advertisements. Example types of physical advertisements include brochures, leaflets, books, catalogs, booklets, flyers, promotional novelties, and other types of physical advertisements.

In various embodiments, the advertising system 206 identifies physical advertisements for the selected consumer in various ways. In one example embodiment, the advertising system 206 identifies physical advertisements for the selected consumer by querying the consumer database 204 for consumer preference information for the selected consumer. The consumer preference information for the selected consumer indicates products or services in which the selected consumer is likely interested. The advertising system 206 then identifies the physical advertisements for the selected consumer by correlating the consumer preference information with available physical advertisements. For instance, if the consumer preference information for the selected consumer indicates that the selected consumer is likely interested in bicycling and the available physical advertisements include a flyer for a bicycle shop, the advertising system 206 identifies the flyer for the selected consumer.

Next, the advertising system 206 operates to distribute the identified physical advertisements to the selected consumer (408). In various embodiments, the advertising system 206 operates to distribute the identified physical advertisements to the selected consumer in various ways. In one example embodiment, where the identified physical advertisements are to be distributed to the selected consumer via mail, the advertising system 206 sends electronic instructions to mail processing equipment to address and send the identified physical advertisements to the selected consumer. In another example embodiment, where the identified physical advertisements are to be distributed to the selected consumer by a private delivery service, the advertising system 206 sends instructions to the private delivery service indicating the identified physical advertisements to send to the selected consumer. After operating to distribute the identified physical advertisements to the selected consumer, the advertising system 206 selects another registered consumer at step 402 and the operation 400 recurs with regard to the other registered consumer.

If the selected consumer has internet access, (“YES” of 404), the advertising system 206 identifies electronic marketing materials for the selected consumer (410). In various embodiments, the electronic marketing materials include various types of electronic marketing materials. Example types of electronic marketing materials include e-mail messages, Short Message Service (SMS) text messages, web site click-through advertisements, Twitter messages, and other types of electronic advertisements. A click-through advertisement is an advertisement that a consumer can click on (or otherwise select) to obtain additional information about the subject matter of the advertisement. Example types of click-through advertisements include banner advertisements and text advertisements on web pages.

In various embodiments, the advertising system 206 identifies electronic advertisements for the selected consumer in various ways. In one example embodiment, the advertising system 206 identifies electronic advertisements for the selected consumer by querying the consumer database 204 for consumer preference information for the selected consumer. The consumer preference information for the selected consumer indicates products or services in which the selected consumer is likely interested. The advertising system 206 then identifies the electronic advertisements for the selected consumer by correlating the consumer preference information with available electronic advertisements. For instance, if the consumer preference information for the selected consumer indicates that the selected consumer lives in a particular neighborhood and the available electronic advertisements include an e-mail advertisement for a restaurant in the particular neighborhood, the advertising system 206 identifies the e-mail advertisement for the selected consumer.

After identifying electronic advertisements for the selected consumer, the advertising system 206 distributes the selected electronic advertisements to the selected consumer (412). The advertising system 206 distributes the electronic advertisements to the selected consumer in various ways depending on the type of the electronic advertisements. For example, the advertising system 206 distributes some of the electronic advertisements by sending one or more e-mail messages to the selected consumer. In another example, the advertising system 206 distributes some of the electronic advertisements by sending one or more SMS text messages to the selected consumer.

FIG. 5 is a flowchart illustrating an example operation 500 to process rewards. It should be appreciated that the operation 500 is merely one example. In other embodiments, operations to process rewards include more or fewer steps or contain the steps of the operation 500 in different sequences.

In the example of FIG. 5, the operation 500 starts when the reward processing system 208 receives a reward request from the consumer 104 or the participating merchant 108 (502). The reward request includes data identifying the consumer 104 (FIG. 1). In various embodiments, the reward processing system 208 receives the reward request in various ways. For instance, in one example embodiment, the reward processing system 208 provides a web interface. In this example embodiment, a computing device of the consumer 104 or the participating merchant 108 sends the reward request to the web interface of the reward processing system 208 via an electronic communications network.

Upon receiving the reward request, the reward processing system 208 retrieves account information of the consumer 104 from the consumer database 204 (504). The account information identifies the rewards account 114 of the consumer 104.

When the reward processing system 208 receives the account information of the consumer 104, the reward processing system 208 calculates a reward amount (506). In various embodiments, the reward processing system 208 calculates the reward amount in various ways. For example, the reward processing system 208 may calculate the reward award amount as a percentage of a purchase price of goods or services purchased from the participating merchant 108. In another example, the reward processing system 208 may calculate the reward amount as a flat amount (e.g., $0.05) when the consumer 104 makes a purchase from the participating merchant 108. In yet another example, the reward processing system 208 calculates the reward amount as a flat amount when the consumer 104 reads an e-mail message containing an advertisement or clicks on a click-through advertisement.

After calculating the reward amount, the reward processing system 208 sends a request to the bank 106 to credit the reward amount to the rewards account 114 of the consumer 104 (508). In various embodiments, the reward processing system 208 sends the request to the bank 106 in various ways. For example, the reward processing system 208 may send a paper check to the bank 106 made out in the reward amount. In another example, the reward processing system 208 sends a request to a bank used by the advertiser 102 to initiate an Automated Clearing House (ACH) entry that debits an account of the advertiser 102 and credits the rewards account 114 in the reward amount.

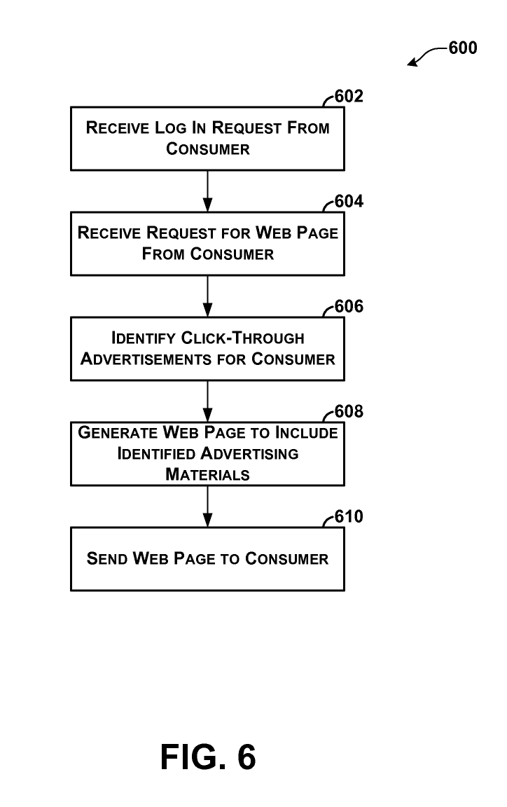

FIG. 6 is a flowchart illustrating an example operation 600 to provide a virtual shopping center website. It should be appreciated that the operation 600 is merely one example. In other embodiments, operations to distribute advertisements to consumers include more or fewer steps or contain the steps of the operation 600 in different sequences.

In some example embodiments, the advertiser computing system 200 hosts a virtual shopping center website. The virtual shopping center website is a website comprising one or more web pages. The web pages include features that allow consumers to purchase goods and services from participating merchants, such as the participating merchant 108 (FIG. 1). Consumers can use their rewards cards to make purchases from the participating merchants in the virtual shopping center website. In some embodiments, the consumers receive discounts on goods or services when they purchase the goods or services through the virtual shopping center website.

In addition, the virtual shopping center website may include other features. For instance, the virtual shopping center website may include features that allow consumers to play games, connect with other people, and so on. Furthermore, in some embodiments, the advertiser 102 uses the virtual shopping center website to distribute surveys to consumers. For instance, the virtual shopping center website may include web pages that allow consumers to provide survey responses to surveys. The survey responses include responses by the consumers to questions in the surveys. The surveys may constitute market research on the part of the advertiser 102 or participating merchants. In such embodiments, when the reward processing system 208 receives survey responses, the reward processing system 208 operates to provide monetary rewards to consumers who provide the survey responses.

In another example, the virtual shopping center website may include a feature that incentivizes consumers to purchase goods and services through the virtual shopping center website by providing entries to the consumers into a prize drawing. In this example, various embodiments provide entries to consumers based on various factors. For example, the advertiser 102 may provide entries to consumers in proportion to lengths of time the consumers use the virtual shopping center website or in proportion to the number or value of purchases made through the virtual shopping center website. When a consumer wins a prize drawing, the advertiser 102 credits a monetary reward to the consumer's rewards account.

In yet another example, the virtual shopping center website presents a question of the day to consumers who access the virtual shopping center website. The question of the day is a question that changes each day. In various embodiments, the questions of the day relate to various topics. In one example embodiment, the questions of the day relate to consumers' perceptions regarding various goods or services. In another example embodiment, the questions of the day relate to consumer tastes and preferences. Thus, answers to the questions of the day may be used as a basis for market research. To incentivize consumers to provide responses to the questions of the day, the advertiser 102 credits a monetary reward to the rewards accounts of consumers who provide responses to the questions of the day.

In yet another example, the advertiser 102 distributes product samples to registered consumers. The virtual shopping center website includes features that allow the registered consumers to provide evaluations of the product samples to the advertiser 102. For example, the virtual shopping center website may include a web form that allows consumers to rate various aspects of the product samples. In other words, the advertiser 102 receives product evaluations from registered consumers via the virtual shopping center website. The product evaluations indicate evaluations by the registered consumers of the product samples. To incentivize consumers to provide responses to the product evaluations, the advertiser 102 credits a monetary reward to the rewards accounts of consumers who provide product evaluations.

In yet another example, the virtual shopping center website includes a virtual sales person feature. The virtual sales person feature is a virtual analogue to a real sales person in a real shopping center. The virtual sales person feature monitors what types of goods and services a consumer is looking at in the virtual shopping center website. The virtual sales person feature then offers to answer the consumer's questions about the types of goods and services. In some embodiments, the answers provided by the virtual sales person feature suggest particular goods or services or higher value versions of the goods and services at which the consumer is looking.

As illustrated in the example of FIG. 6, the operation 600 begins when the advertising system 206 receives a request from the consumer 104 to log in to a virtual shopping center website (602). By logging in to the virtual shopping center website, the advertising system 206 is made aware of an identity of the consumer 104. The advertising system 206 also receives a request from the consumer 104 for a web page in the virtual shopping center website (604). In some embodiments, the request to log in to the virtual shopping center website and the request for the web page in the virtual shopping center website are the same request.

In response to receiving the request for the web page, the advertising system 206 identifies click-through advertisements for the consumer 104 (606). To identify advertisements for the consumer 104, the advertising system 206 retrieves consumer preference information from the consumer database 204. The consumer preference information for the consumer 104 indicates products or services in which the consumer 104 is likely interested. The advertising system 206 then identifies the click-through advertisements for the consumer 104 by correlating the consumer preference information with available click-through advertisements. For instance, if the consumer preference information for the consumer 104 indicates that the consumer 104 is likely interested in shoes and the available click-through advertisements include a banner ad for a shoe store, the advertising system 206 identifies the banner ad for the consumer 104.

After identifying the click-through advertisements for the consumer 104, the advertising system 206 generates the web page to include one or more of the identified click-through advertisements (608). For example, the advertising system 206 may alter HTML code of the web page such that a banner ad appears in the web page.

After generating the web page, the advertising system 206 sends the web page to a computing system used by the consumer 104 (610). A web browser application operating on the computing system used by the consumer 104 renders and displays the web page. At some time after the advertising system 206 sends the web page to the computing system used by the consumer 104, the reward processing system 208 may receive a reward request from the consumer 104 when the consumer 104 clicks on one of the click-through advertisements on the web page. In response, the reward processing system 208 may provide a monetary award to the consumer.

FIG. 7 is a block diagram illustrating an example computing device 700 usable in the advertising system. In some embodiments, the advertiser computing system 200 (FIG. 2), computing devices used by the consumer 104 (FIG. 1), the bank 106, the participating merchant 108, the non-participating merchant 110, and/or the ATM 112, are implemented using one or more computing devices like the computing device 700. It should be appreciated that in other embodiments, the advertiser computing system 200 and the computing devices used by the consumer 104, the bank 106, the participating merchant 108, the non-participating merchant 110 and/or the ATM 112 are implemented using computing devices having hardware components other than those illustrated in the example of FIG. 7.

In different embodiments, computing devices are implemented in different ways. For instance, in the example of FIG. 7, the computing device 700 comprises a memory 702, a processing unit 704, a secondary storage device 706, a network interface card 708, a video interface 710, a display device 712, an external component interface 714, an external storage device 716, an input device 718, a printer 720, and a communication medium 722. In other embodiments, computing devices are implemented using more or fewer hardware components. For instance, in another example embodiment, a computing device does not include a video interface, a display device, an external storage device, or an input device.

The memory 702 includes one or more computer-readable data storage media capable of storing data and/or instructions. In different embodiments, the memory 702 is implemented in different ways. For instance, in various embodiments, the memory 702 is implemented using various types of computer-readable data storage media. Example types of computer-readable data storage media include, but are not limited to, dynamic random access memory (DRAM), double data rate synchronous dynamic random access memory (DDR SDRAM), reduced latency DRAM, DDR2 SDRAM, DDR3 SDRAM, Rambus RAM, solid state memory, flash memory, read-only memory (ROM), electrically-erasable programmable ROM, and other types of devices and/or articles of manufacture that store data.

The processing unit 704 includes one or more physical integrated circuits that selectively execute software instructions. In various embodiments, the processing unit 704 is implemented in various ways. For instance, in one example embodiment, the processing unit 704 is implemented as one or more processing cores. For instance, in this example embodiment, the processing unit 704 may be implemented as one or more Intel Core 2 microprocessors. In another example embodiment, the processing unit 704 is implemented as one or more separate microprocessors. In yet another example embodiment, the processing unit 704 is implemented as an ASIC that provides specific functionality. In yet another example embodiment, the processing unit 704 provides specific functionality by using an ASIC and by executing software instructions.

In different embodiments, the processing unit 704 executes software instructions in different instruction sets. For instance, in various embodiments, the processing unit 704 executes software instructions in instruction sets such as the x86 instruction set, the POWER instruction set, a RISC instruction set, the SPARC instruction set, the IA-64 instruction set, the MIPS instruction set, and/or other instruction sets.

The secondary storage device 706 includes one or more computer-readable data storage media. The secondary storage device 706 stores data and software instructions not directly accessible by the processing unit 704. In other words, the processing unit 704 performs an I/O operation to retrieve data and/or software instructions from the secondary storage device 706. In various embodiments, the secondary storage device 706 is implemented by various types of computer-readable data storage media. For instance, the secondary storage device 706 may be implemented by one or more magnetic disks, magnetic tape drives, CD-ROM discs, DVD-ROM discs, Blu-Ray discs, solid state memory devices, Bernoulli cartridges, and/or other types of computer-readable data storage media.

The network interface card 708 enables the computing device 700 to send data to and receive data from a computer communication network. In different embodiments, the network interface card 708 is implemented in different ways. For example, in various embodiments, the network interface card 708 is implemented as an Ethernet interface, a token-ring network interface, a fiber optic network interface, a wireless network interface (e.g., WiFi, WiMax, etc.), or another type of network interface.

The video interface 710 enables the computing device 700 to output video information to the display device 712. In different embodiments, the video interface 710 is implemented in different ways. For instance, in one example embodiment, the video interface 710 is integrated into a motherboard of the computing device 700. In another example embodiment, the video interface 710 is a video expansion card. Example types of video expansion cards include Radeon graphics cards manufactured by ATI Technologies, Inc. of Markham, Ontario, Geforce graphics cards manufactured by Nvidia Corporation of Santa Clara, Calif., and other types of graphics cards.

In various embodiments, the display device 712 is implemented as various types of display devices. Example types of display devices include, but are not limited to, cathode-ray tube displays, LCD display panels, plasma screen display panels, touch-sensitive display panels, LED screens, projectors, and other types of display devices. In various embodiments, the video interface 710 communicates with the display device 712 in various ways. For instance, in various embodiments, the video interface 710 communicates with the display device 712 via a Universal Serial Bus (USB) connector, a VGA connector, a digital visual interface (DVI) connector, an S-Video connector, a High-Definition Multimedia Interface (HDMI) interface, a DisplayPort connector, or other types of connectors.

The external component interface 714 enables the computing device 700 to communicate with external devices. In various embodiments, the external component interface 714 is implemented in different ways. For instance, in one example embodiment, the external component interface 714 is a USB interface. In other example embodiments, the computing device 700 is a FireWire interface, a serial port interface, a parallel port interface, a PS/2 interface, and/or another type of interface that enables the computing device 700 to communicate with external components.

In different embodiments, the external component interface 714 enables the computing device 700 to communicate with different external components. For instance, in the example of FIG. 7, the external component interface 714 enables the computing device 700 to communicate with the external storage device 716, the input device 718, and the printer 720. In other embodiments, the external component interface 714 enables the computing device 700 to communicate with more or fewer external components. Other example types of external components include, but are not limited to, speakers, phone charging jacks, modems, media player docks, other computing devices, scanners, digital cameras, a fingerprint reader, and other devices that can be connected to the computing device 700.

The external storage device 716 is an external component comprising one or more computer readable data storage media. Different implementations of the computing device 700 interface with different types of external storage devices. Example types of external storage devices include, but are not limited to, magnetic tape drives, flash memory modules, magnetic disk drives, optical disc drives, flash memory units, zip disk drives, optical jukeboxes, and other types of devices comprising one or more computer-readable data storage media. The input device 718 is an external component that provides user input to the computing device 700. Different implementations of the computing device 700 interface with different types of input devices. Example types of input devices include, but are not limited to, keyboards, mice, trackballs, stylus input devices, key pads, microphones, joysticks, touch-sensitive display screens, and other types of devices that provide user input to the computing device 700. The printer 720 is an external device that prints data to paper. Different implementations of the computing device 700 interface with different types of printers. Example types of printers include, but are not limited to laser printers, ink jet printers, photo printers, copy machines, fax machines, receipt printers, dot matrix printers, or other types of devices that print data to paper.

The communications medium 722 facilitates communication among the hardware components of the computing device 700. In different embodiments, the communications medium 722 facilitates communication among different components of the computing device 700. For instance, in the example of FIG. 7, the communications medium 722 facilitates communication among the memory 702, the processing unit 704, the secondary storage device 706, the network interface card 708, the video interface 710, and the external component interface 714. In different implementations of the computing device 700, the communications medium 722 is implemented in different ways. For instance, in different implementations of the computing device 700, the communications medium 722 may be implemented as a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computing system Interface (SCSI) interface, or another type of communications medium.

The memory 702 stores various types of data and/or software instructions. For instance, in the example of FIG. 7, the memory 702 stores a Basic Input/Output System (BIOS) 524, an operating system 526, application software 528, and program data 530. The BIOS 524 includes a set of software instructions that, when executed by the processing unit 704, cause the computing device 700 to boot up. The operating system 526 includes a set of software instructions that, when executed by the processing unit 704, cause the computing device 700 to provide an operating system that coordinates the activities and sharing of resources of the computing device 700. Example types of operating systems include, but are not limited to, Microsoft Windows, Linux, Unix, Apple OS X, Apple OS X iPhone, Palm webOS, Palm OS, Google Chrome OS, Google Android OS, and so on. The application software 528 includes a set of software instructions that, when executed by the processing unit 704, cause the computing device 700 to provide applications to a user of the computing device 700. The program data 530 is data generated and/or used by the application software 528.

The various embodiments described above are provided by way of illustration only and should not be construed as limiting. Those skilled in the art will readily recognize various modifications and changes that may be made without following the example embodiments and applications illustrated and described herein.

We claim:

1. A computer-implemented method for distributing advertisements, the computer-implemented method comprising:
distributing, by an advertiser, advertisements to consumers;
receiving, by a computing system associated with the advertiser, reward requests from the consumers when the consumers have consumed the advertisements and from participating merchants when the consumers perform transactions with the participating merchants; and
in response to receiving the reward requests, crediting a monetary reward to a rewards account,
the rewards accounts exclusively containing money from monetary rewards credited to the rewards accounts by the advertiser,
the consumers being able to use money in the rewards accounts for purchases from the participating merchants and non-participating merchants.

2. The computer-implemented method of claim 1, wherein the rewards accounts are interest-bearing.

3. The computer-implemented method of claim 1 further comprising: sending rewards cards to the consumers, the rewards cards allowing the consumers to make purchases from the participating merchants and the non-participating merchants.

4. The computer-implemented method of claim 3, wherein the consumers are able to use the rewards cards at an automatic teller machine (ATM) to withdraw money from the rewards accounts.

5. The computer-implemented method of claim 1,
wherein distributing the advertisements to the consumers comprises: sending e-mail messages to the consumers; and
wherein receiving the reward requests comprises: receiving, by the computing system, indications from computing devices used by the consumers that the consumers have read the e-mail messages.

6. The computer-implemented method of claim 1, wherein receiving the reward requests comprises: receiving, by the computing system, indications from computing devices used by given ones of the participating merchants that the consumers have made purchases from the given ones of the participating merchants.

7. The computer-implemented method of claim 1, wherein the consumers are able to use money in the rewards accounts to reduce purchase prices of purchases from ones of the participating merchants at times when the consumers makes the purchases.

8. The computer-implemented method of claim 1,
wherein distributing the advertisements to the consumers comprises:
receiving, by the computing system, requests from consumer computing devices to access a web page, the consumer computing devices being computing devices used by the consumers; and
sending the web page to the consumer computing devices, the web page containing at least one of the advertisements; and
wherein receiving the reward requests comprises: receiving, by the computing system, indications that the consumers have clicked on the at least one of the advertisements.

9. The computer-implemented method of claim 1, further comprising:
distributing, by the advertiser, surveys to the consumers;
receiving, by the advertiser, survey responses, the survey responses comprising responses by the consumers to questions in the surveys; and
in response to receiving the survey responses, crediting additional monetary awards to the rewards accounts.

10. The computer-implemented method of claim 9, further comprising:
distributing, by the advertiser, product samples to the consumers;
receiving, by the advertiser, product evaluations from the consumers, the product evaluations indicating evaluations of the product samples by the consumers; and
in response to receiving the product evaluations, crediting further monetary awards to the rewards accounts.

11. The computer-implemented method of claim 10, further comprising: prior to distributing the advertisements to the consumers, automatically selecting, by the computing system, the advertisements for distribution to the consumers by correlating preferences of the consumers with the advertisements.

12. A computing system comprising a set of computing devices, the set of computing devices including at least one computing device, the set of computing devices configured such that the computing system:
distributes advertisements to consumers;
receives reward requests from the consumers when the consumers have consumed the advertisements and from participating merchants when the consumers perform transactions with the participating merchants; and
in response to receiving the reward requests, credits monetary rewards to rewards accounts,
the rewards accounts exclusively containing money from monetary rewards credited to the rewards accounts by an advertiser,
the consumers being able to use money in the rewards accounts for purchases from the participating merchants and non-participating merchants.

13. The computing system of claim 12,
wherein the computing system distributes the advertisements to the consumers at least in part by sending e-mail messages to the consumers; and
wherein the computing system receives the reward requests at least in part by receiving indications from computing devices used by the consumers that the consumers have read the e-mail messages.

14. The computing system of claim 12,
wherein the computing system distributes the advertisements to the consumers at least in part by:
receiving a request from a consumer computing device to access a web page, the consumer computing device being a computing device used by a given one of the consumers; and
sending the web page to the consumer computing device, the web page containing the advertisement; and
wherein the computing system receives the reward requests at least in part by receiving an indication that the given one of the consumers has clicked on the advertisement.

15. The computing system of claim 12, wherein the computing system further:
distributes surveys to the consumers;
receives survey responses, the survey responses comprising responses by the consumers to questions in the surveys; and
credits, in response to receiving the survey responses, additional monetary awards to the rewards accounts.

16. The computing system of claim 12, wherein the computing system further:
distributes product samples to the consumers;
receives product evaluations from the consumers, the product evaluations indicating evaluations of the product samples by the consumers; and
credits, in response to receiving the product evaluations, further monetary awards to the rewards accounts.

17. The computing system of claim 12, wherein prior to distributing the advertisements to the consumers, the computing system automatically selects the advertisements for distribution to the consumers based on preferences of the consumers.

18. A computer-readable data storage medium comprising instructions that, when executed by a processing unit of a computing device, cause the computing device to:
distribute advertisement to consumers;
receive reward requests indicating that the consumers have consumed the advertisements and from participating merchants when the consumers perform transactions with the participating merchants; and
in response to receiving the reward requests, credit monetary rewards to rewards accounts,
the rewards accounts exclusively containing money from monetary rewards credited to the rewards accounts by an advertiser,
the consumers being able to use money in the rewards accounts for purchases from participating merchants and non-participating merchants.

19. The computer-readable data storage medium of claim 18, wherein the instructions further cause the computing device to: send rewards cards to the consumers, the rewards cards allowing the consumers to make purchases from the participating merchants and the non-participating merchants.

20. The computer-readable data storage medium of claim 18,
wherein the computing device distributes the advertisements to the consumers at least in part by sending e-mail messages to the consumers; and
wherein the computing device receives the reward requests at least in part by receiving indications from computing devices used by the consumers that the consumers have read the e-mail messages.
